(19) United States
(12) Patent Application Publication
(10) Pub. No.: US 2025/0358103 A1
(43) Pub. Date: Nov. 20, 2025

(54) METHOD FOR SESSION KEY EXCHANGE BETWEEN TERMINALS AND TERMINAL PERFORMING THE SAME

(71) Applicants: AGENCY FOR DEFENSE DEVELOPMENT, Daejeon (KR); KOREA UNIVERSITY RESEARCH AND BUSINESS FOUNDATION, Seoul (KR)

(72) Inventors: Ik Rae JEONG, Seoul (KR); Jae Yeol JEONG, Asan-si (KR); Min Seob LEE, Seoul (KR)

(21) Appl. No.: 18/886,161

(22) Filed: Sep. 16, 2024

(30) Foreign Application Priority Data
May 16, 2024 (KR) 10-2024-0063753
Jul. 5, 2024 (KR) 10-2024-0088935

(51) Int. Cl. H04L 9/08; H04L 9/06; H04L 9/32

(52) U.S. Cl. CPC H04L 9/0825; H04L 9/0643; H04L 9/3242

(57) ABSTRACT

Provided is a session key exchange method of a first terminal, the session key exchange method including determining a first pseudonym identifier (PID), of the first terminal, to be used in a communication session with a second terminal, transferring the first PID to the second terminal, transferring a first cipher text and a first message authentication code (MAC) value identified based on a second PID identified from the second terminal and the first PID to the second terminal, and identifying a session key to be used in the communication session with the second terminal based on the second PID, a second cipher text, a second MAC value, which are identified from the second terminal, and the first PID.

### PRIORITY INFORMATION

This application claims the benefit of Korean Patent Application Nos. 10-2024-0063753, filed on May 16, 2024, and 10-2024-0088935, filed on Jul. 5, 2024, in the Korean Intellectual Property Office, the disclosures of which are incorporated herein by reference.

### FIELD OF THE INVENTION

The present disclosure relates to a method for session key exchange between terminals and a terminal performing the same.

### DISCUSSION OF THE RELATED ART

In an environment of the Internet of drones (IoD), a secret key of a drone is revealed under a drone-capturing attack. Nevertheless, a session key used in a previous communication session and anonymity of a user participating in the previous communication session are required to be protected. Here, a feature for protecting the session key used in the previous communication session is referred to as forward secrecy, and a feature for protecting the anonymity of the user participating the previous communication session is referred to as forward unlinkability.

The related art includes a technology of lightweight remote user authentication and session key exchange, which is developed by Wazid in 2018, and an improved technology thereof by Srinivas et al. However, the technologies described above have a security issue that other authenticated users may calculate a session key set by another user. In addition, a technology for a consensus protocol developed by Zhang et al., in 2020, which uses only a hash function and an XOR calculation, may not provide the forward unlinkability. A session key exchange protocol developed by Jeong et al., in 2022 is significant as an earliest technology of providing all of the forward secrecy and the forward unlinkability. However, the session key exchange protocol provides weak forward secrecy only, not standard forward secrecy. Also, in the session key exchange protocol, a drone is incapable of simultaneously executing key exchange sessions with multiple users, and communication with a server is always required for setting each session key.

Accordingly, a method of achieving the standard forward secrecy and standard forward unlinkability without the disadvantage described above is required.

### SUMMARY OF THE INVENTION

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. However, the goals to be achieved by example embodiments of the present disclosure are not limited to the objectives described herein and other objects may be clearly understood from the following example embodiments.

An aspect provides a method for session key exchange between terminals and a terminal performing the same. Specifically, a purpose thereof is to establish an environment of the Internet of drones, which has high resistance to a drone-capturing attack, through a simultaneous mutual key exchange protocol that guarantees forward unlinkability.

According to an aspect, there is provided a session key exchange method of a first terminal, the session key exchange method including determining a first pseudonym identifier (PID), of the first terminal, to be used in a communication session with a second terminal, transferring the first PID to the second terminal, transferring a first cipher text and a first message authentication code (MAC) value identified based on a second PID identified from the second terminal and the first PID to the second terminal, and identifying a session key to be used in the communication session with the second terminal based on the second PID, a second cipher text, a second MAC value, which are identified from the second terminal, and the first PID.

The session key exchange method may further include, before the determining of the first PID, identifying a public parameter including a group of prime order, a generator corresponding to the group of prime order, a public key, a first hash function, and a second hash function from a server, transferring a first identifier (ID) of the first terminal to the server, and identifying a first secret key and a first verification key corresponding to the first ID from the server.

The transferring of the first cipher text and the first MAC value to the second terminal may include identifying an encryption key and a MAC key corresponding to the communication session by inputting the first PID and the second PID to a second hash function, and identifying the first cipher text and the first MAC value based on the encryption key and the MAC key.

The identifying of the session key may include identifying that integrity of the second cipher text has been verified based on the second MAC value, identifying a second decrypted text including a second ID of the second terminal, a value corresponding to a second secret key, and a second verification key by decrypting the second cipher text, identifying that correctness of the value corresponding to the second secret key has been verified based on the second ID and the second verification key, and identifying the session key by inputting the first PID, the second PID, a value corresponding to a first secret key of the first terminal, and a value corresponding to the second secret key to a second hash function.

The identifying of that correctness of the value corresponding to the second secret key has been verified may include inputting the second ID and the second verification key to a first hash function, and identifying that a result of calculating an output value of the first hash function, a public key, and the second verification key is equal to a value corresponding to the second secret key.

The session key exchange method may further include transferring, after encrypting information based on the session key, the encrypted information to the second terminal.

The session key exchange method may further include identifying information, which is encrypted based on the session key, from the second terminal which identifies the session key by inputting, to a second hash function, the first PID which is identified from the first terminal, a value corresponding to a first secret key identified from the first terminal, the second PID of the second terminal, which is identified through interlocking with a server, and a value corresponding to a second secret key of the second terminal.

The first terminal may correspond to a manager terminal, and the second terminal may correspond to a drone terminal.

According to another aspect, there is also provided a non-transitory computer-readable recording medium including a program for executing a session key exchange method in a computer, and the session key exchange method includes determining a first pseudonym identifier (PID), of the first terminal, to be used in a communication session with a second terminal, transferring the first PID to the second terminal, transferring a first cipher text and a first message authentication code (MAC) value identified based on a second PID identified from the second terminal and the first PID to the second terminal, and identifying a session key to be used in the communication session with the second terminal based on the second PID, a second cipher text, a second MAC value, which are identified from the second terminal, and the first PID.

According to still another aspect, there is also provided a first terminal configured to exchange a session key, the first terminal including a processor, and a memory configured to store one or more instructions, and the processor is configured to, by executing the one or more instructions, determine a first pseudonym identifier (PID), of the first terminal, to be used in a communication session with a second terminal, transfer the first PID to the second terminal, transfer a first cipher text and a first message authentication code (MAC) value identified based on a second PID identified from the second terminal and the first PID to the second terminal, and identify a session key to be used in the communication session with the second terminal based on the second PID, a second cipher text, a second MAC value, which are identified from the second terminal, and the first PID.

Additional aspects of example embodiments will be set forth in part in the description which follows and, in part, will be apparent from the description, or may be learned by practice of the disclosure.

According to example embodiments, it is possible to expect the one or more following effects.

According to example embodiments, it is possible to establish an environment of the Internet of drones, which has high resistance to a drone-capturing attack, through a simultaneous mutual key exchange protocol that guarantees forward unlinkability.

In addition, according to example embodiments, a manager terminal or a drone terminal may simultaneously execute communication sessions for multiple terminals without communication with a server.

Effects of the present disclosure are not limited to those described above and other effects may be made apparent to those skilled in the art from the following description. It is to be understood that both the foregoing general description and the following detailed description are examples and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram illustrating interlocking relationship between terminals and a server exchanging a session key according to an example embodiment;

FIG. 2 is a flowchart illustrating a session key exchange method according to an example embodiment;

FIG. 3 is a diagram illustrating a protocol setup process performed between a first terminal and a server according to an example embodiment;

FIG. 4 is a diagram illustrating a session key exchange process between a first terminal and a second terminal according to an example embodiment;

FIG. 5 is a diagram illustrating a case in which a session key is exposed due to a drone-capturing attack in an environment of the Internet of drones not guaranteeing forward secrecy according to the related art;

FIG. 6 is a diagram illustrating a case in which user information on a previous session is exposed due to a drone-capturing attack in an environment of the Internet of drones not guaranteeing forward unlinkability according to the related art; and

FIG. 7 is a block diagram illustrating a first terminal according to an example embodiment.

### DETAILED DESCRIPTION

Terms used in the example embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element.

Throughout the specification, expression “at least one of a, b, and c” may include ‘a only’, ‘b only’, ‘c only’, ‘a and b’, ‘a and c’, ‘b and c’, or ‘all of a, b, and c’.

In the present disclosure, a “terminal” may be implemented as a computer or a portable terminal capable of accessing a server or another terminal through a network. Here, the computer may include, for example, a laptop computer, a desktop computer, and a notebook equipped with a web browser. The portable terminal may be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, example embodiments of the present disclosure will be described in detail with reference to the accompanying drawings so that those skilled in the art can easily carry out the present disclosure. The present disclosure may be embodied in many different forms and is not limited to the example embodiments described herein.

Hereinafter, the example embodiments of the present disclosure will be described with reference to the drawings.

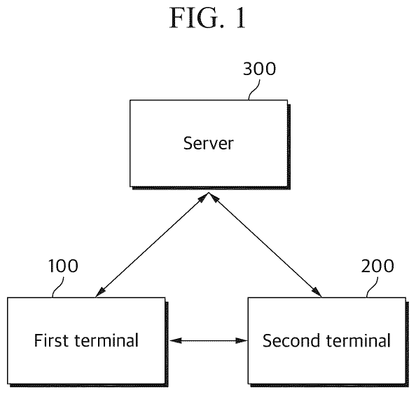

FIG. 1 is a diagram illustrating interlocking relationship between terminals and a server exchanging a session key according to an example embodiment.

Referring to FIG. 1, a first terminal 100 may be interlocked with a second terminal 200 and a server 300 and operate. Meanwhile, only elements associated with the present example embodiment are illustrated in FIG. 1. Thus, those skilled in the art associated with the present example embodiment may understand that other elements in general use may be included in addition to the elements illustrated in FIG. 1.

According to an example embodiment, the server 300 may operate as a control server for setting up a protocol in association with communication between the first terminal 100 and the second terminal 200. As described below, at a time of executing a communication session of the first terminal 100 and the second terminal 200, the first terminal 100 or the second terminal 200 each may individually execute the communication session without involvement of the sever. A protocol setup as preliminary work for executing such a communication session may be performed by communicating with the server 300.

According to an example embodiment, the first terminal 100 may correspond to one of at least one manager terminal, the second terminal 20 may correspond to one of a plurality of drone terminals. In other words, the first terminal 100 may be a manager terminal used by at least one manager managing the plurality of drone terminals, and the second terminal 200 may be a communication device loaded in one of the plurality of drone terminals. For convenience, a case in which the first terminal 100 is to execute the communication session earlier will be assumed and described. The second terminal 200 may execute the communication session earlier in a course identical to the following description only with an entity changed.

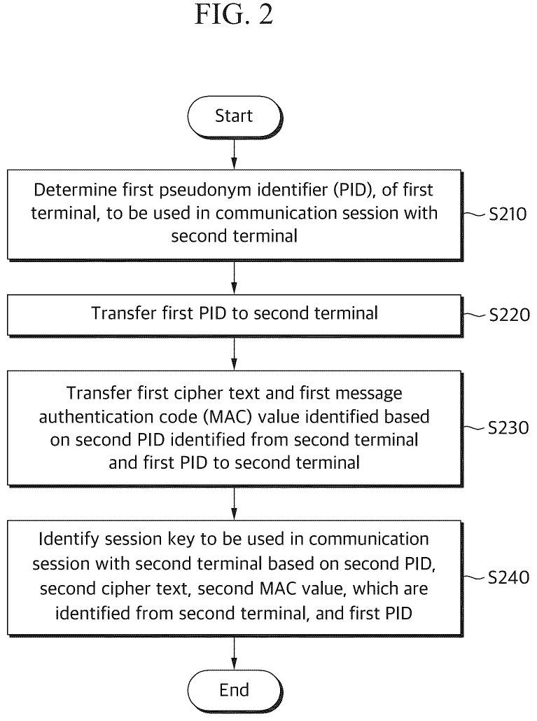

FIG. 2 is a flowchart illustrating a session key exchange method according to an example embodiment.

In operation S210, the first terminal 100 may determine a first pseudonym identifier (PID), of the first terminal, to be used in a communication session with the second terminal 200. In operation S220, the first terminal 100 may transfer the first PID to the second terminal 200. In operation S230, the first terminal 100 may transfer a first cipher text and a first message authentication code (MAC) value identified based on a second PID identified from the second terminal 200 and the first PID to the second terminal 200. In operation S240, the first terminal 100 may identify a session key to be used in the communication session with the second terminal 200 based on the second PID, a second cipher text, a second MAC value, which are identified from the second terminal 200, and the first PID.

Hereinafter, each operation will be described in detail.

To begin with, a protocol setup process that may be processed before the above-described operations S210 through S240 will be described. The first terminal 100 may identify a public parameter including a group of prime order, a generator corresponding to the group of prime order, a public key, a first hash function, and a second hash function from the server 300. Here, the group of prime order may be a group in which the number of elements is a prime number. The generator may be a number that may show all elements in the group of prime order by raising the generator to a power. The public key may be a value obtained by calculating a master secret key through the generator. The first hash function and the second hash function may be, as a predetermined hash function stored in the server 300, a hash function in which input and output is set for performing an operation that will be described below. Such a definition of the public parameter may be shown as the following Equation 1.

$$MPK = ( 𝔾 , g , y , {H}_{1} , {H}_{2} ) \qquad [ Equation 1 ]$$

wherein [symbol] is a group of prime order q, where q is θ bits long,
   g ∈ [symbol] is a random generator,
   H₁:{0,1}*→ [symbol] _{q} and H_{2:}{0,1}*→{0,1}^{θ}
   y=g^{x} where x← [symbol] _{q} is picked randomly

In Equation 1, [symbol] _{q} may denote an integer set including integers from 0 to q. {0,1}* may denote a sequence having an unfixed length and including a combination of 0 and 1. {0,1}^{θ} may denote a sequence which is 0 bits long and includes a combination of 0 and 1. MPK in Equation 1 may denote a master public key, namely, the public parameter. The server 300 may reveal the public parameter and may hide and store x as the master secret key.

As such, the first terminal 100 may identify the public parameter and transfer a first identifier (ID) of the first terminal 100 to the server 300. The server 300 may identify the first ID of the first terminal 100 and generate a first secret key and a first verification key corresponding to the first ID. Further specifically, the first verification key which is denoted by r_{ID}_{ᵢ} and the first secret key which is denoted by s_{ID}_{ᵢ} may be generated as shown in the following Equation 2.

$${r}_{{ID}_{i}} = {g}^{k} , {s}_{{ID}_{i}} = k + {H}_{1} ( {ID}_{i} , {r}_{{ID}_{i}} ) x wherein k ← {ℤ}_{q} is randomly picked \qquad [ Equation 2 ]$$

In description of a process according to Equation 2, the server 300 may randomly pick k from elements of the [symbol] _{q}. Then, the server 300 may generate the first verification key denoted by r_{ID}_{ᵢ}=g^{k} by calculation through the generator which is denoted by g. In addition, the master secret key which is denoted by the x and an output obtained by inputting the first ID and the first verification key to the first hash function may be multiplied together, the above-described random k may be added, and accordingly, the first secret key s_{ID}_{ᵢ} may be generated. Afterward, the first terminal 100 may identify the first verification key and the first secret key from the server 300. Such a first verification key and a first secret key may be a value hidden and stored as a secret key by the first terminal 100.

The above description may be identically applied to the second terminal 200. In other words, the second terminal 200 may identify the public parameter including the group of prime order, the generator corresponding to the group of prime order, the public key, the first hash function, and the second hash function from the server 300. Also, the second terminal 200 may transfer a second ID of the second terminal 200 to the server 300. The server 300 may generate a second verification key and a second secret key corresponding to the second ID as shown in Equation 2, and the second terminal 200 may identify the second verification key and the second secret key from the server 300. The second verification key and the second secret key of the second terminal 200 may be identified according to Equation 3.

$${r}_{{ID}_{j}} = {g}^{l} , {s}_{{ID}_{j}} = l + {H}_{1} ( {ID}_{j} , {r}_{{ID}_{j}} ) \times wherein l ← {ℤ}_{q} is randomly picked \qquad [ Equation 3 ]$$

According to Equation 3, the server 300 may randomly pick l from the elements of the [symbol] _{q}. Then, the server 300 may generate the second verification key which is denoted by r_{ID}_{ⱼ}=g^{l} by calculation through the generator denoted by the g. Also, the master secret key denoted by the x and an output obtained by inputting the second ID and the second verification key to the first hash function may be multiplied together, the above-described random I may be added, and accordingly, the second secret key which is denoted by s_{ID}_{ₗ} may be generated. Afterward, the second terminal 200 may identify the second verification key and the second secret key from the server 300. Such a second verification key and a second secret key may be a value hidden and stored as a secret key by the first terminal 100.

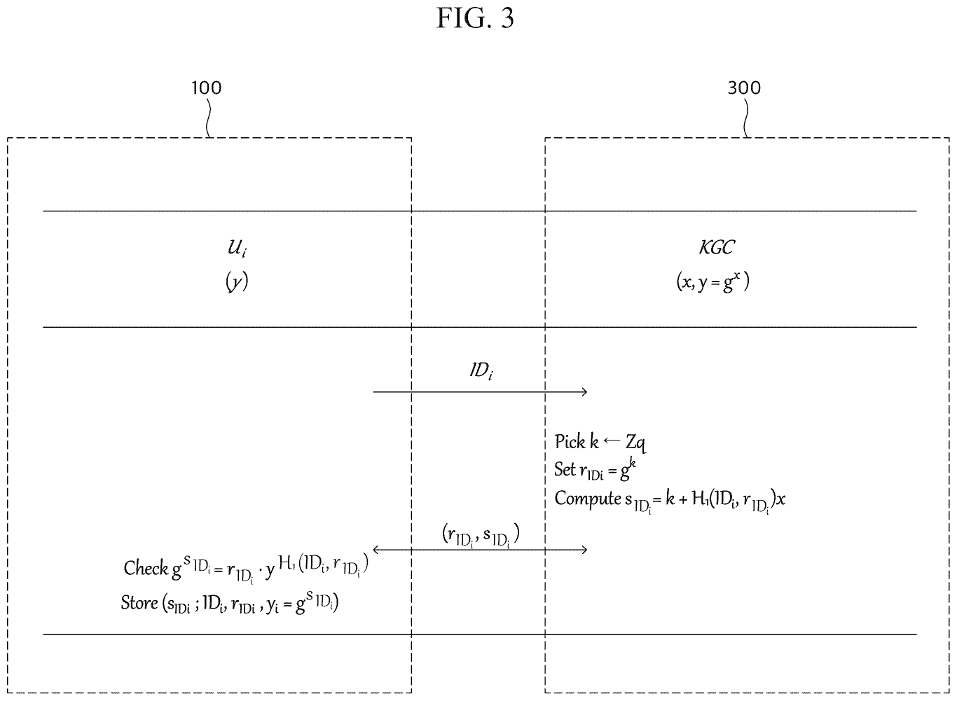

The above-described protocol setup process will be described in detail with reference to FIG. 3.

FIG. 3 is a diagram illustrating a protocol setup process performed between a first terminal and a server according to an example embodiment.

FIG. 3 is under an assumption that the first terminal 100 which is denoted by Uᵢ includes a public key denoted by y in a state of having already acquired a public parameter. The first terminal 100 may transfer a first ID denoted by IDᵢ to the server 300 which is denoted by KGC, and accordingly, the server 300 may transfer s_{ID}_{ᵢ} and r_{ID}_{ᵢ} that are identified by performing an operation of the above-described Equation 2. The first terminal 100 may verify the transferred s_{ID}_{ᵢ} and store the first ID denoted by the IDᵢ and the s_{ID}_{ᵢ} together with a value denoted by yᵢ and calculated with a generator denoted by g. A process of verifying the s_{ID}_{ᵢ} and use of the value denoted by yᵢ will be described below in detail with reference to Equation 10.

When such a protocol setup process is completed, the first terminal 100 or the second terminal 200 may perform a communication session with each other. An example embodiment in which the first terminal 100 executes a communication session with the second terminal will be described in the following description.

Initially, the first terminal 100 may determine a first PID to be used in the communication session with the second terminal 200. Specifically, the first terminal 100 may randomly select an element denoted by rᵢ of [symbol] _{q} and then calculate the first PID, namely, PIDᵢ=g^{r}^{ᵢ} by using the generator denoted by the g. The first terminal 100 may transfer the first PID which is identified as such to the second terminal 200.

The second terminal 200 may identify a second PID of the second terminal 200 in a similar way when the first PID is identified. Specifically, the second terminal 200 may randomly select an element denoted by rⱼ of the [symbol] _{q} and then calculate the second PID, namely, PIDⱼ=g^{r}^{ⱼ} by using the generator denoted by the g. In addition, the second terminal 200 may identify an encryption key and an MAC key corresponding to a communication session with the first terminal 100 by inputting the first PID and the second PID to a second hash function. Specifically, the second terminal 200 may identify the encryption key and the MAC key as shown in the following Equation 4.

$${ek}_{i , j} = {H}_{2} ( {PID}_{i} ‖ {PID}_{j} ‖ {g}^{{r}_{i} {r}_{j}} ‖ 0 ) , \qquad [ Equation 4 ]$$

$${mk}_{i , j} {H}_{2} ( {PID}_{i} ‖ {PID}_{j} ‖ {g}^{{r}_{i} {r}_{j}} ‖ 1 )$$

That is, as shown in Equation 4, the second terminal 200 may sequentially concatenate the first PID which is denoted by PIDᵢ, the second PID which is denoted by PIDⱼ, and g^{r}^{ᵢ}^{r}^{ⱼ} that is a product of the first PID and the second PID, may additionally concatenate 0 to an end of one concatenation and 1 to an end of another concatenation, and then may input the concatenations to the second hash function. Afterward, an output of an input value in which 0 is concatenated to the end of the one concatenation may be identified as the encryption key, and an output of an input value in which 1 is concatenated to the end of the other concatenation may be identified as the MAC key. Whether to concatenate 0 or 1 to an end is optional. Thus, the output of the input value in which 0 is concatenated to the end of the one concatenation may be identified as the MAC key, and the output of the input value in which 1 is concatenated to the end of the other concatenation may be identified as the encryption key. As identifiable in Equation 3, the encryption key and the MAC key may be ek_{i,j} and mk_{i,j}, respectively, which are values corresponding to a communication session between a component i representing the first terminal 100 and a component j representing the second terminal 200.

Afterward, the second terminal 200 may identify a second cipher text and a second MAC value based on the encryption key and the MAC key. As described below, a first cipher text and a first MAC value may be calculated by the first terminal 100. To revert to description of the second cipher text and the second MAC value, the second terminal 200 may identify the second cipher text based on the encryption key as shown in Equation 5.

$${c}_{j} = {𝔼}_{{ek}_{i , j}} ( {ID}_{j} ‖ {r}_{{ID}_{j}} ‖ {y}_{j} ) where {y}_{j} = {g}^{{s}_{{ID}_{j}}} \qquad [ Equation 5 ]$$

In Equation 5, cⱼ may denote the second cipher text. Eₑₖ_{_{i,j}} may denote an encryption function using the encryption key. IDⱼ may denote a second ID of the second terminal 200. r_{ID}_{ⱼ} may denote a second verification key. yⱼ may denote a value that is identified by calculating a second secret key denoted by s_{ID}_{ⱼ} with the generator denoted by the g and corresponds to the second secret key. Here, the encryption function may be implemented by using a symmetric key encryption algorithm such as an advanced encryption standard (AES), but it is merely an example.

Also, the second terminal 200 may identify the second MAC value based on the MAC key as shown in Equation 6.

$${τ}_{j} = M a {c}_{m {k}_{i , j}} ( {PID}_{j} ‖ {PID}_{i} ‖ {c}_{j} ) \qquad [ Equation 6 ]$$

In Equation 6, τⱼ may denote the second MAC value. The PIDᵢ may denote the first PID. The PIDⱼ may denote the second PID. The cⱼ may denote the second cipher text. Macₘₖ_{_{i,j}} may denote an MAC value generation function using the MAC key. Here, the MAC value generation function may be implemented by using a hash MAC (HMAC) algorithm, a cipher-based MAC (CMAC) algorithm, a Galois MAC (GMAC) algorithm or the like, but it is merely an example.

According to an example embodiment, the second terminal 200 may transfer the second cipher text, the second MAC value, which are identified based on Equations 5 and 6, and the second PID to the first terminal 100.

The first terminal 100 may identify the second PID, the second cipher text, and the second MAC value from the second terminal 200. At this point, the first terminal 100 may perform (i) an identification process for the first cipher text and the first MAC value to transfer to the second terminal 200 and (ii) a session key identification process using the first PID, the second PID, the second cipher text, and the second MAC value.

The former identification process, namely, the identification process for the first cipher text and the first MAC value to transfer to the second terminal 200 may be relatively similar to a process according to the above-described Equations 4 through 6. Specifically, the first terminal 100 may generate the encryption key and the MAC key, which may be identical to a process of Equation 4. In other words, since the first terminal 100 is in a state of having the first PID of the first terminal 100 and simultaneously in a state of identifying the second PID from the second terminal 200, as shown in Equation 4, the first terminal 100 may generate the encryption key and the MAC key which correspond to the communication session by inputting the first PID and the second PID to the second hash function. Since inputs and functions are all identical, outputs may be also all identical, and accordingly, the first terminal 100 and the second terminal 200 may have an identical encryption key and an identical MAC key. As described below, the first terminal 100 may use the encryption key and the MAC key which the first terminal 100 acquires as identically as the second terminal 200 does in such a way so as to verify integrity of the second cipher text which is acquired from the second terminal 200 and decrypt the second cipher text. Similarly, the second terminal may also verify integrity of the first cipher text which is acquired from the first terminal 100 and decrypt the first cipher text. The first terminal 100 and the second terminal 200 shares the encryption key and the MAC key as such, but the first cipher text and the first MAC value which are generated by the first terminal 100 are different from the second cipher text and the second MAC value which are generated by the second terminal 200. Specifically, the first terminal 100 may identify the first cipher text and the first MAC value based on the encryption key and the MAC key. Particularly, the first terminal 100 may generate the first cipher text according to Equation 7.

$${c}_{i} = {E}_{e {k}_{i , j}} ( {ID}_{i} ‖ {r}_{{ID}_{i}} ‖ {y}_{i} ) where {y}_{i} = {g}^{{s}_{{ID}_{i}}} \qquad [ Equation 7 ]$$

In Equation 7, cᵢ may denote the first cipher text. The Eₑₖ_{_{i,j}} may denote the encryption function using the encryption key, the IDᵢ may denote the first ID of the first terminal 100. r_{ID}_{ᵢ} may denote a first verification key. yᵢ may denote a value that is identified by calculating a first secret key denoted by s_{ID}_{ᵢ} with the generator denoted by the g and corresponds to the first secret key. Here, the encryption function may be identical to that used in the second terminal 200.

In addition, the first terminal 100 may generate the first MAC value according to Equation 8.

$${τ}_{i} = M a {c}_{m {k}_{i , j}} ( {PID}_{i} ‖ {PID}_{j} ‖ {c}_{i} ) \qquad [ Equation 8 ]$$

In Equation 8, τⱼ may denote the first MAC value. The PIDᵢ may denote the first PID. The PIDⱼ may denote the second PID. The cᵢ may denote the first cipher text. The Macₘₖ_{_{i,j}} may denote the MAC value generation function using the MAC key. Here, the MAC value generation function may be identical to that used in the second terminal 200.

As described above, since the first terminal 100 may use the encryption key, the encryption function, the MAC key, and the MAC value generation function which are shared with the second terminal 200. However, since different values are input to the function, the output first cipher text and the first MAC value are different from the second cipher text and the second MAC value.

The first terminal 100 may transfer the first cipher text and the first MAC value generated as such to the second terminal 200. Then, the latter identification process performed by the first terminal 100, namely, the session key identification process using the first PID, the second PID, the second cipher text, and the second MAC value will be described. As described below, the second terminal 200 which identifies the first cipher text and the first MAC value may also perform a similar process.

According to an example embodiment, the first terminal 100 may verify whether the second cipher text has the integrity based on the second MAC value. Verification of whether the second cipher text has the integrity based on the second MAC value may be performed according to the following Equation 9.

$$integrity is intact if {Vrfy}_{{mk}_{i , j}} ( {PID}_{j} ‖ {PID}_{i} ‖ {c}_{j} , {τ}_{j} ) = 1 \qquad [ Equation 9 ]$$

In Equation 9, Vrfyₘₖ_{_{i,j}} may denote an integrity verification function based on the MAC key which is denoted by mk_{i,j}. According to an example embodiment, the integrity verification function may be a function that generates an MAC value with a front input denoted by PIDⱼ∥PIDᵢ∥cⱼ of the function and then outputs 1 when the MAC value is equal to a rear input denoted by the τⱼ. In other words, the first terminal 100 may generate the MAC value by performing a process identical to a process performed with the second MAC value by the second terminal 200 and determine the second cipher text to have the integrity when the MAC value is equal to the second MAC value.

After identifying that the integrity of the second cipher text has been verified, the first terminal 100 may identify a second decrypted text including the second ID of the second terminal 200, the value corresponding to the second secret key, and the second verification key by decrypting the second cipher text. Here, decryption may be performed by a decryption function determined according to the encryption function which is used to generate the second cipher text. In a process thereof, the encryption key identified through the above-described process may be used. Afterward, the first terminal 100 may verify correctness of the second secret key based on the second ID and the second verification key included in the second decrypted text. Specifically, as shown in Equation 10, the first terminal 100 may verify the correctness of the value corresponding to the second secret key by inputting the second ID and the second verification key to a first hash function and identifying whether a result of calculating an output value of the first hash function, a public key, and the second verification key is equal to the value corresponding to the second secret key.

$$correctness is intact if {y}_{j} = {r}_{{ID}_{j}} {y}^{{H}_{1} ( {ID}_{j} , {r}_{{ID}_{j}} )} \qquad [ Equation 10 ]$$

In Equation 10, the yⱼ may denote the value corresponding to the second secret key. The r_{ID}_{ⱼ} may denote the second verification key. The IDⱼ may denote the second ID. y may denote the public key. A reason why the correctness of the value corresponding to the second secret key may be verified according to the above-described equation will be described. The second secret key has been determined to be s_{ID}_{ⱼ}=l+H₁(IDⱼ,r_{ID}_{ⱼ})x as shown in Equation 3. This equality may be

$${g}^{{s}_{{ID}_{j}}} = {g}^{l + {H}_{1} ( {ID}_{j} , {r}_{{ID}_{j}} ) x}$$

when indexed with the generator denoted by g and may be also converted into

$${y}_{j} = {r}_{{ID}_{j}} {y}^{{H}_{1} ( {ID}_{j} , {r}_{{ID}_{j}} )}$$

As identifiable through such a conversion process, the yⱼ may be equal to

$${r}_{{ID}_{j}} {y}^{{H}_{1} ( {ID}_{j} , {r}_{{ID}_{j}} )}$$

when exactly being the value corresponding to the second secret key. The first terminal 100 may verify the correctness of the value corresponding to the second secret key by using such relationship.

According to an example embodiment, as shown in Equation 10, the second terminal 200 may input the second ID and the second verification key to the first hash function and identify that the result of calculating the output value of the first hash function, the public key, and the second verification key is equal to the value corresponding to the second secret key. After the first terminal 100 identifies that the correctness of the value corresponding to the second secret key has been verified accordingly, the first terminal 100 may identify a session key by inputting the first PID, the second PID, the value corresponding to the first secret key of the first terminal 100, and the value corresponding to the second secret key to the second hash function. Specifically, the first terminal 100 may identify the session key according to

Equation 11.

$$s {k}_{i , j} = {H}_{2} ( {PID}_{i} ‖ {PID}_{j} ‖ {g}^{{s}_{{ID}_{i}}} {g}^{{s}_{{ID}_{j}}} ‖ {g}^{{r}_{i}} {g}^{{r}_{j}} ) \qquad [ Equation 11 ]$$

In Equation 11, the PIDᵢ may denote the first PID. The PIDⱼ may denote the second PID

$${g}^{{s}_{{ID}_{i}}} {g}^{{s}_{{ID}_{j}}}$$

may denote a value identifiable by multiplying the value corresponding to the first secret key by the value corresponding to the second secret key. g^{r}^{ᵢ}g^{r}^{ⱼ} may denote a value identifiable by multiplying the first PID and the second PID. The first terminal 100 may concatenate such values and then identify the session key which is denoted by sk_{i,j} by inputting the values to the second hash function.

The second terminal 200 may also identify the session key denoted by the sk_{i,j} through a process similar to Equations 9 through 11. Specifically, the second terminal 200 may verify whether the first cipher text has the integrity according to Equation 12.

$$integrity is intact if {Vrfy}_{{mk}_{i , j}} ( {PID}_{i} ‖ {PID}_{j} ‖ {c}_{i} , {τ}_{i} ) = 1 \qquad [ Equation 12 ]$$

As having been sufficiently described above, a definition of each symbol and function included in Equation 12 will be omitted. After the second terminal 200 identifies the integrity of the first cipher text according to Equation 12, the second terminal 200 may identify a first decrypted text including the first ID, the value corresponding to the first secret key, and the first verification key. The second terminal 200 may verify correctness of the value corresponding to the first secret key according to Equation 13.

$$correctness is intact if {y}_{i} = {r}_{{ID}_{i}} {y}^{{H}_{1} ( {ID}_{i} , {r}_{{ID}_{i}} )} \qquad [ Equation 13 ]$$

As having been sufficiently described above, a definition of each symbol and function included in Equation 13 will be also omitted. After the second terminal 200 verifies the correctness of the value corresponding to the first secret key, the second terminal 200 may identify the session key denoted by the sk_{i,j} by performing a calculation identical to Equation 11.

When exchange of the session key is completed as such, after encrypting information based on the session key, the first terminal 100 may transfer the encrypted information to the second terminal 200. In an identical way, after encrypting information based on the session key, the second terminal 200 may transfer the encrypted information to the first terminal 100. The first terminal 100 may identify the information encrypted based on the session key from the second terminal 200.

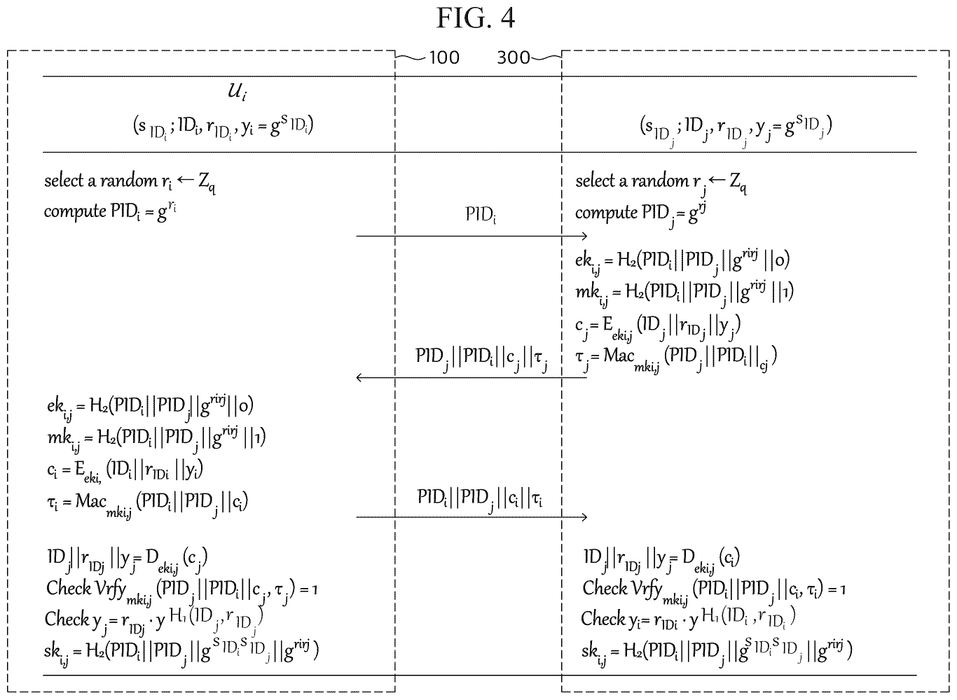

A series of the processes described above will be described overall below with reference to FIG. 4.

FIG. 4 is a diagram illustrating a session key exchange process between a first terminal and a second terminal according to an example embodiment.

Referring to FIG. 4, a series of processes in which the first terminal 100 which is denoted by Uᵢ identifies a session key by inputting a second PID identified from the second terminal 200 which is denoted by Dⱼ, a value corresponding to a second secret key and identified from the second terminal 200, a first PID of the first terminal 100 identified through interlocking with the server 300, and a value corresponding to a first secret key of the first terminal 100 to a second hash function and a series of processes in which the second terminal 200 which is denoted by Dⱼ identifies the session key by inputting the first PID which is identified from the first terminal 100 denoted by Uᵢ, the value corresponding to the first secret key and identified from the first terminal 100, the second PID of the second terminal 200 which is identified through interlocking with the server 300, and the value corresponding to the second secret key of the second terminal 200 to the second hash function may be identified in detail. Values and functions illustrated in a drawing has been mostly described through the above-described Equations 1 through 13. IDⱼ∥r_{ID}_{ⱼ}∥yⱼ=Dₑₖ_{_{i,j}}(cⱼ) and IDᵢ∥r_{ID}_{ᵢ}∥yᵢ=Dₑₖ_{_{i,j}}(cᵢ) may be equations not shown in Equations 1 through 13 and may represent identification, by decrypting a second cipher text denoted by cⱼ and a first cipher text denoted by cᵢ with a decryption function denoted by D using an encryption key denoted by ek_{i,j}, of a second decrypted text and a first decrypted text, respectively.

Hereinafter, an effect of exchanging the session key according to the above-described example embodiment will be described.

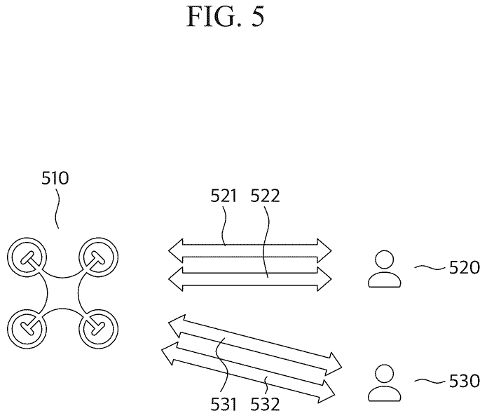

To begin with, FIG. 5 will be referenced for description of forward secrecy that is a first feature acquirable by exchanging the session key according to example embodiments of the present disclosure.

FIG. 5 is a diagram illustrating a case in which a session key is exposed due to a drone- capturing attack in an environment of the Internet of drones not guaranteeing forward secrecy according to the related art.

Referring to FIG. 5, a drone 510 may perform communication with a first user 520 and a second user 530 through first and second sessions 521 and 522 and through third and fourth sessions 531 and 532, respectively. At this point, when a communication protocol of the drone 510 does not guarantee the forward secrecy, and when the drone 510 is under the drone-capturing attack, namely, an attack of analyzing an internal memory in a way such as capturing or hacking a drone itself, a danger that the session key for first through fourth sessions is exposed due to calculation using a long-term secret key, which is exposed through analysis, of the drone 510 may occur.

According to example embodiments of the present disclosure, the session key may not be exposed in spite of the drone-capturing attack such as that illustrated in FIG. 5. Specifically, in example embodiments of the present disclosure, a new temporary key may be generated for each session by applying a Diffie-Hellman key exchange protocol. At this point, since a manager terminal and a drone terminal may select respective random values denoted by rᵢ and rⱼ, namely, PIDs for each session and generate a temporary key based thereon, although a long-term secret key of the drone terminal, for example, s_{ID}_{ⱼ} of the present disclosure is exposed due to a memory of the drone terminal being analyzed, a session key of communication sessions to which a corresponding drone is connected may be safely protected.

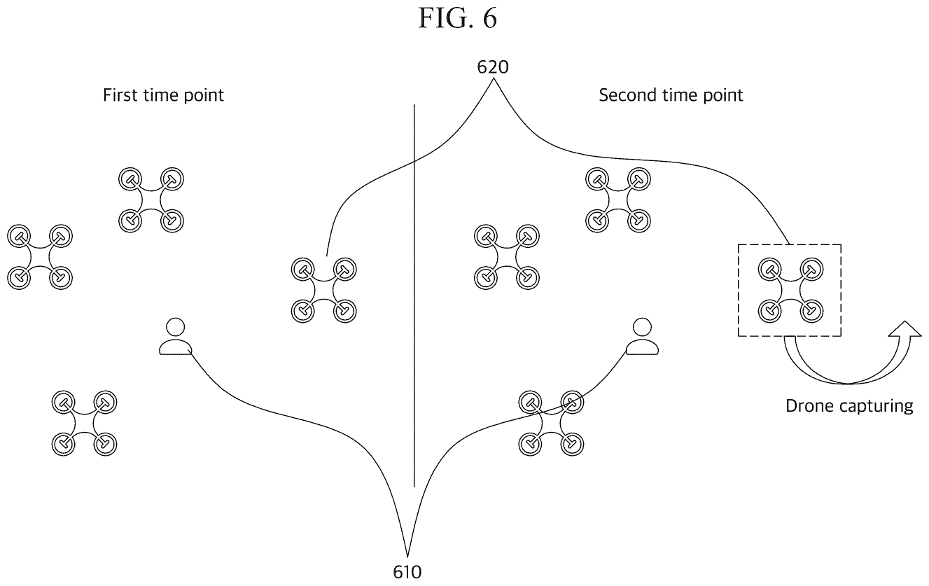

Then, FIG. 6 will be referenced for description of forward unlinkability that is a second feature acquirable by exchanging the session key according to example embodiments of the present disclosure.

FIG. 6 is a diagram illustrating a case in which user information on a previous session is exposed due to a drone-capturing attack in an environment of the Internet of drones not guaranteeing forward unlinkability according to the related art.

Referring to FIG. 6, a situation in which an identical manager manages identical drones through a manager terminal 610 at different time points may be identified. At this point, when a communication protocol not guaranteeing the forward unlinkability is used, and when an internal memory of a drone 620 is analyzed due to the drone-capturing attack at a second time point, which drone has been present and which manager terminal has managed the drones at a first time point may be exposed.

According to example embodiments of the present disclosure, anonymity of a user participating in a session at an earlier time point may be maintained in spite of the drone-capturing attack such as that illustrated in FIG. 6. Specifically, according to example embodiments of the present disclosure, since a manager terminal and a drone terminal generate a PID for each session and communicate by using a PID different for each session, and since an encryption key and an MAC key are also generated based on the PID different for each session, which terminal is another user connected for each session through communication may be unknown even if the drone terminal is captured and an internal memory is analyzed at a time point. Thus, the forward unlinkability may be guaranteed according to the present disclosure.

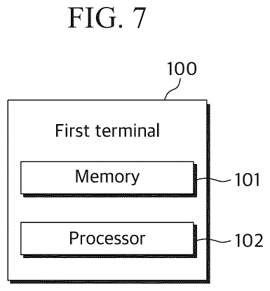

FIG. 7 is a block diagram illustrating a first terminal according to an example embodiment.

The first terminal 100 may include a memory 101 and a processor 102 according to an example embodiment. Only elements, which are associated with the present example embodiment, of the first terminal 100 which is illustrated in FIG. 7 are illustrated. Thus, those skilled in the art associated with the present example embodiment may understand that other elements in general use may be included in addition to the elements illustrated in FIG. 7. In an example embodiment, the processor 102 may be included in a controller.

The processor 102 may control overall operations of the first terminal 100 and may process data and a signal. The processor 102 may include at least one hardware unit. In addition, the processor 102 may be operated by one or more software module generated by executing program code stored in the memory 101. Since the processor 102 may include the memory 101, the processor 102 may execute the program code stored in the memory 101 to control the overall operations of the first terminal 100 and process the data and the signal.

The processor 102 may execute one or more instructions to determine a first pseudonym identifier (PID), of the first terminal 100, to be used in a communication session with the second terminal 200, transfer the first PID to the second terminal 200, transfer a first cipher text and a first message authentication code (MAC) value identified based on a second PID identified from the second terminal 200 and the first PID to the second terminal 200, and identify a session key to be used in the communication session with the second terminal 200 based on the second PID, a second cipher text, a second MAC value, which are identified from the second terminal, and the first PID.

Depending on example embodiments, the first terminal 100 may additionally include a transceiver for performing wired/wireless communication. The first terminal 100 may communicate with the external second terminal 200 or server 300 by using the transceiver. Also, a communication technology used by the transceiver may include Global System for Mobile communication (GSM), Code Division Multi Access (CDMA), Long Term Evolution (LTE), 5th Generation, (5G), a wireless local area network (WLAN), Wireless-Fidelity (Wi-Fi), Bluetooth, radio frequency identification (RFID), infrared data association (IrDA), ZigBee, near field communication (NFC), or the like.

The first terminal 100 according to the above-described example embodiments may include a processor, a memory that stores and executes program data, a permanent storage such as a disk drive, a communication port for communicating with an external device, and a user interface device such as a touch panel, a key, and an icon. Methods implemented by software modules or algorithms may be stored in a computer-readable recording medium as computer-readable code or program instructions executable in the processor. Here, the computer-readable recording medium may include a magnetic storage medium (e.g., a read-only memory (ROM), a random-access memory (RAM), a floppy disk, a hard disk, or the like), an optical reading medium (e.g., a CD-ROM or a digital versatile disc (DVD)), or the like. The computer-readable recording medium may be dispersed to computer systems connected by a network so that computer-readable codes may be stored and executed in a dispersion manner. The medium may be read by a computer, stored in the memory, and executed by the processor.

The above description associated with a hardware element of the first terminal 100 may be applied to the second terminal 200 and the server 300. Thus, the second terminal 200 and the server 300 may also include an element similar to that described above.

The present embodiments may be represented by functional blocks and various processing steps. These functional blocks may be implemented by various numbers of hardware and/or software configurations that execute specific functions. For example, the present embodiments may adopt integrated circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler language including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

It will be apparent to those skilled in the art that various modifications and variations can be made in the embodiment of the present invention without departing from the spirit or scope of the invention. Thus, it is intended that the present invention cover the modifications and variations of this invention provided they come within the scope of the appended claims and their equivalents.

What is claimed is:

1. A session key exchange method of a first terminal, the session key exchange method comprising:
determining a first pseudonym identifier (PID), of the first terminal, to be used in a communication session with a second terminal;
transferring the first PID to the second terminal;
transferring a first cipher text and a first message authentication code (MAC) value identified based on a second PID identified from the second terminal and the first PID to the second terminal; and
identifying a session key to be used in the communication session with the second terminal based on the second PID, a second cipher text, a second MAC value, which are identified from the second terminal, and the first PID.

2. The session key exchange method of claim 1, further comprising, before the determining of the first PID:
identifying a public parameter including a group of prime order, a generator corresponding to the group of prime order, a public key, a first hash function, and a second hash function from a server;
transferring a first identifier (ID) of the first terminal to the server; and
identifying a first secret key and a first verification key corresponding to the first ID.

3. The session key exchange method of claim 1, wherein the transferring of the first cipher text and the first MAC value comprises:
identifying an encryption key and a MAC key corresponding to the communication session by inputting the first PID and the second PID to a second hash function; and
identifying the first cipher text and the first MAC value based on the encryption key and the MAC key.

4. The session key exchange method of claim 1, wherein the identifying of the session key comprises:
identifying that integrity of the second cipher text has been verified based on the second MAC value;
identifying a second decrypted text including a second ID of the second terminal, a value corresponding to a second secret key, and a second verification key by decrypting the second cipher text;
identifying that correctness of the value corresponding to the second secret key has been verified based on the second ID and the second verification key; and
identifying the session key by inputting the first PID, the second PID, a value corresponding to a first secret key of the first terminal, and the value corresponding to the second secret key to a second hash function.

5. The session key exchange method of claim 4, wherein the identifying of that correctness of the value corresponding to the second secret key has been verified comprises:
inputting the second ID and the second verification key to a first hash function; and
identifying that a result of calculating an output value of the first hash function, a public key, and the second verification key is equal to the value corresponding to the second secret key.

6. The session key exchange method of claim 1, further comprising transferring, after encrypting information based on the session key, the encrypted information to the second terminal.

7. The session key exchange method of claim 1, further comprising identifying information, which is encrypted based on the session key, from the second terminal which identifies the session key by inputting, to a second hash function:
the first PID which is identified from the first terminal;
a value corresponding to a first secret key identified from the first terminal;
the second PID of the second terminal, which is identified through interlocking with a server; and
a value corresponding to a second secret key of the second terminal.

8. The session key exchange method of claim 1, wherein the first terminal corresponds to a manager terminal, and
the second terminal corresponds to a drone terminal.

9. A non-transitory computer-readable recording medium comprising a program for executing a session key exchange method in a computer, the program comprising instructions for:
determining a first pseudonym identifier (PID), of a first terminal, to be used in a communication session with a second terminal;
transferring the first PID to the second terminal;
transferring a first cipher text and a first message authentication code (MAC) value identified based on a second PID identified from the second terminal and the first PID to the second terminal; and
identifying a session key to be used in the communication session with the second terminal based on the second PID, a second cipher text, a second MAC value, which are identified from the second terminal, and the first PID.

10. A first terminal configured to exchange a session key, the first terminal comprising:
a processor; and
a non-transitory memory configured to store one or more instructions, wherein the processor is configured to, by executing the one or more instructions:
determine a first pseudonym identifier (PID), of the first terminal, to be used in a communication session with a second terminal;
transfer the first PID to the second terminal;
transfer a first cipher text and a first message authentication code (MAC) value identified based on a second PID identified from the second terminal and the first PID to the second terminal; and
identify a session key to be used in the communication session with the second terminal based on the second PID, a second cipher text, a second MAC value, which are identified from the second terminal, and the first PID.
